(19) United States
(12) Patent Application Publication
(10) Pub. No.: US 2021/0350308 A1
(43) Pub. Date: Nov. 11, 2021

(54) INFORMATION PROCESSING DEVICE, INFORMATION PROCESSING METHOD, AND COMPUTER PROGRAM

(71) Applicant: A&B COMPUTER CORPORATION, Tokyo (JP)

(72) Inventors: Kouichi CHIBA, Tokyo (JP); Hiroshi MATSUZAWA, Tokyo (JP); Takenori CHIBA, Tokyo (JP)

(21) Appl. No.: 17/277,528

(22) PCT Filed: Sep. 18, 2019
(86) PCT No.: PCT/JP2019/036565

§ 371 Date: Mar. 18, 2021

(30) Foreign Application Priority Data
Sep. 19, 2018 (JP) 2018-174854

(51) Int. Cl. G06Q 10/06; G06K 9/62

(52) U.S. Cl. CPC G06Q 10/063112; G06K 9/6256; G06K 9/628; G06Q 10/0639

(57) ABSTRACT

An information processing device includes: an input unit for causing attribute values that can be converted to at least binary values to be inputted for each of multiple kinds of attributes pertaining to the persons to be classified; an attribute image generation unit for generating an attribute image having multiple areas corresponding to the multiple kinds of attributes, each of the multiple areas exhibiting a color that corresponds to the attribute value inputted for the attribute corresponding thereto; and a determination engine having a learned model that has learned a correlation between a pattern of the attribute values and the result of classification on the basis of a learning data set in which the pattern of the attribute values for the attributes is represented in the same format as that for the attribute image. The determination engine outputs the result of classification, on the basis of the attribute image.

### TECHNICAL FIELD

The present invention relates to an information processing device, and particularly to an information processing device for classifying ICT (information and communication technology) engineers and the like on the basis of a variety of attributes such as skills and qualifications that they hold.

### BACKGROUND ART

In a case of recruiting or dispatching, for example, ICT engineers, it is sometimes desired to group, or classify, a multiplicity of ICT engineers on the basis of skills and qualifications that the engineers hold individually. However, there are a wide variety of skills and qualifications relating to ICT engineering, and it is not easy to set suitable classification rules.

For example, JP-A-2002-203053 discloses a skill certification system with which it is possible to quantitatively evaluate skills of members of an aggregate with a computer automatically, on the basis of evaluation items, wherein the aggregate is composed of multiple members, and the evaluation items are job experiences, qualifications held, training programs attended, and the like.

With the above-described system disclosed in JP-A-2002-203053, it is possible to set weights to the respective evaluation items, but the weighting has to be done by humans. This therefore leads to a problem that the more evaluation items there are, the more difficult it is to set appropriate weights in order to achieve desired classification.

### SUMMARY OF THE INVENTION

### Brief Description of the Drawings

FIG. 1 is a block diagram illustrating a schematic configuration of an information processing device in Embodiment 1.

FIG. 2 illustrates an exemplary check list generated by a check list generation unit.

FIG. 3 illustrates an attribute image obtained from the check list shown in FIG. 2.

FIG. 4 is a block diagram illustrating a schematic configuration of a determiner generation system for generating a learned model of a determination engine.

FIG. 5 illustrates an exemplary attribute list for generating learning data.

FIG. 6 illustrates an exemplary attribute image obtained from the attribute list shown in FIG. 5.

FIG. 7 illustrates an exemplary attribute image obtained from the attribute list shown in FIG. 5.

FIG. 8 illustrates an exemplary image obtained from the attribute list shown in FIG. 5.

FIG. 9 illustrates exemplary learning data generated from the attribute image shown in FIG. 6.

FIG. 10 is a schematic diagram illustrating exemplary attribute images of five types of engineers.

FIG. 11 illustrates exemplary learning data generated from the attribute image shown in FIG. 10.

FIG. 12 illustrates an attribute image of an engineer (person to be classified) input for verification.

FIG. 13 is a graph showing results of determination by a learned model 14a.

FIG. 14 is a block diagram illustrating a schematic configuration of an information processing device in Embodiment 2.

FIG. 15 illustrates an exemplary check list generated by a check list generation unit in Embodiment 2.

FIG. 16 illustrates an attribute image obtained from the check list shown in FIG. 15.

### EMBODIMENTS OF THE INVENTION

The following description describes embodiments of the present invention in detail, while referring to the drawings. Identical or equivalent parts in the drawings are denoted by the same reference numerals, and the descriptions of the same are not repeated.

### Embodiment 1

ICT engineers are mentioned as a single group, but they can be classified in a variety of classifications. For example, there are various categories of engineers such as web engineers, network engineers, database engineers, front-end engineer, embedded engineers, server engineers, and infrastructure engineers. In addition, there is no clear and unique definition regarding what skill, qualification, knowledge, or experience a person is required to have to fall in which of these engineer categories. Therefore, conventionally it has been difficult to automatically classify ICT engineers.

An information processing device of the present embodiment receives input of a variety of attribute information regarding ICT engineers as objects to be classified (hereinafter referred to as “persons to be classified”), and automatically determines the engineer category using a learned model.

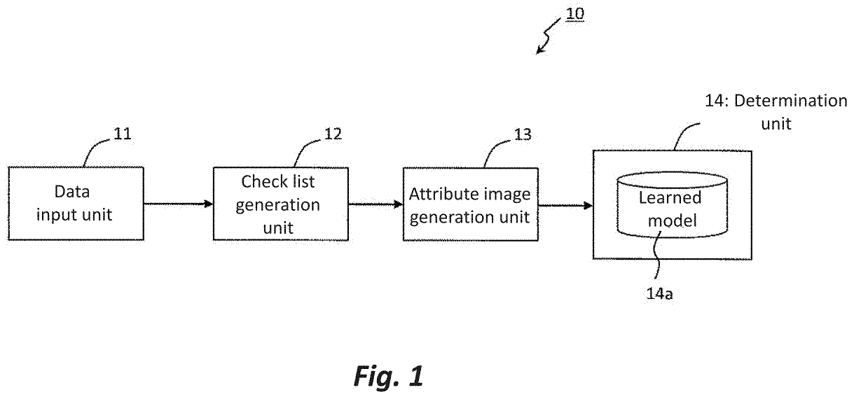

FIG. 1 is a block diagram illustrating a schematic configuration of an information processing device 10. The information processing device 10 can be configured with one or multiple computers. In other words, all of the blocks shown in FIG. 1 may be implemented by one computer, or the blocks shown in FIG. 1 may be dispersedly arranged in multiple computers connected via a network.

As illustrated in FIG. 1, the information processing device 10 includes a data input unit 11, a check list generation unit 12, an attribute image generation unit 13, and a determination unit 14. The data input unit 11 receives input of attribute information pertaining to the persons to be classified. The check list generation unit 12 generates, regarding each person to be classified, a check list in which checkboxes of attributes that the person has are checked, based on attribute information that the data input unit 11 has received. The attribute image generation unit 13 converts the check list generated by the check list generation unit 12 into an attribute image having an n-row×n-column matrix of squares (n is an integer of 2 or more). The determination unit 14 inputs the attribute image obtained by the attribute image generation unit 13, determines which one of predetermined engineer categories the person to be classified belongs to, by using a determination engine 14a configured with a learned model, and outputs the determination result.

The data input unit 11 may be a known input device such as a keyboard and a mouse for receiving input of attribute information directly from a user, or may read text data and extract attribute information contained in the text data by performing morpheme analysis or the like. In the latter case, for example, from a text of an electronic mail, text data of a curriculum vitae and resume, or the like sent from a job applicant, attribute information of the job applicant can be extracted.

Attribute information contains arbitrary attributes pertaining to the persons to be classified. For example, the attribute information may contain information about a programming language that the person to be classified can work with, development environments (e.g., Linux (registered trademark), Windows (registered trademark)), fields in which the systems that he/she has developed were applied (e.g., finance, distribution, food, traffic), years of experience, qualifications held, tasks experienced, skills held, and the like, which are, however, merely examples.

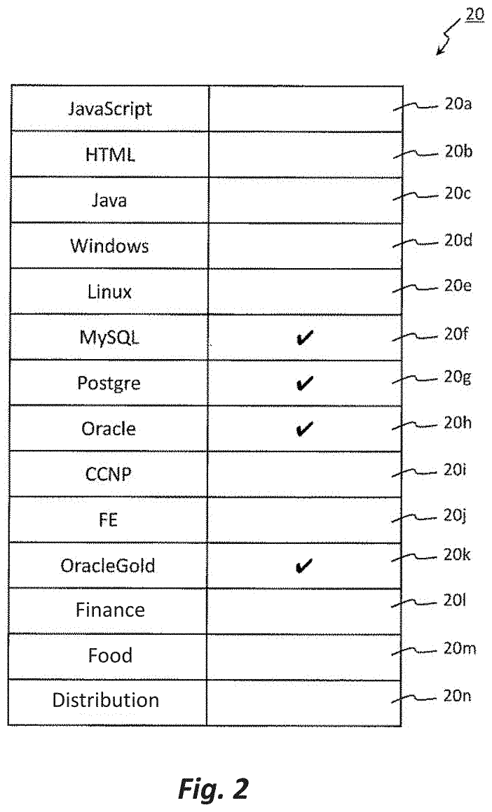

The check list generation unit 12 makes a check list whose image is, for example, as shown in FIG. 2, based on attribute information input from the data input unit 11. Incidentally, FIG. 2 is a conceptual diagram obtained by visualizing the check list. Actually, a check list is generated as digital data that indicate, regarding each attribute item, whether a person to be classified has the attribute, with a binary value (true or false, for example, “1” or “0”).

The check list 20 shown in FIG. 2 is generated on the basis of attribute information of a person to be classified. In the example shown in FIG. 2, the check list 20 has checkboxes 20a to 20n, and the boxes of attributes that the person to be classified has are checked. More specifically, in the check list 20 shown in FIG. 2, the checkboxes 20f, 20g, 20h, and 20k are checked, which indicates that the person to be classified has development experiences (or has a certified qualification) in MySQL (registered trademark), Postgre (registered trademark), Oracle (registered trademark), and OracleGold (registered trademark). Incidentally, for convenience of explanation, only 14 types of attributes are shown in FIG. 2, but the number and the types of attributes are not limited to those in this example; they are arbitrary.

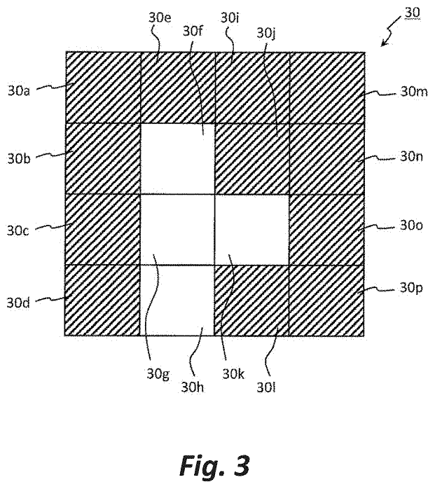

The attribute image generation unit 13 converts the check list 20 into an attribute image 30 shown in FIG. 3. The attribute image 30 is an image having a 4-row×4-column matrix of squares, in which the squares 30a to 30n correspond to the checkboxes 20a to 20n of the check list 20. The squares 30f, 30g, 30h, and 30k respectively corresponding to the checkboxes 20f, 20g, 20h, and 20k, which are checked in the check list 20, are colored in white, and the squares corresponding to the checkboxes 30a to 30e, 30i, 30j, and 30l to 30n, which are not checked, are colored in black. The squares 30o and 30p, which correspond to no checkbox, are also colored in black. Incidentally, in FIG. 3, the squares to be colored in black are indicated by hatching, for convenience sake.

It should be noted that in the example shown in FIG. 3, the checkboxes 20a to 20d in the check list 20 are allocated to the squares 30a to 30d in the leftmost column of the attribute image 30 in order from the top, respectively; the checkboxes 20e to 20h are allocated to the squares 30e to 30h in the second column from the left in order from the top, respectively; the checkboxes 20i to 20l are allocated to the squares 30i to 30l in the third column from the left in order from the top, respectively; and the checkboxes 20m and 20n are allocated to the squares 30m and 30n in the fourth column from the left in order from the top, respectively. Regarding the allocation of the checkboxes 20a to 20n of the check list 20 to the squares of the attribute image 30, the order of allocation is not limited to that described above, as long as the allocation by the same method is applied to all of the persons to be classified.

The attribute image generated in this way is input to the determination unit 14, and which one of predetermined engineer categories the person to be classified belongs to is determined by the determination engine 14a.

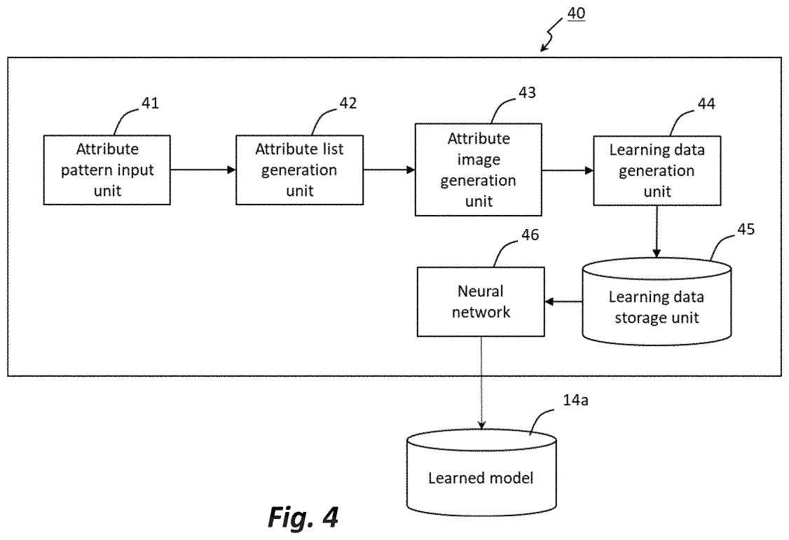

As described above, the determination engine 14a is a learned model. The following description explains a method for generating a learned model of the determination engine 14a, while referring to FIGS. 4 to 9.

The determination engine 14a is generated by machine learning such as deep learning. It should be noted that the method for generating a learned model, specifically described hereinafter, is a supervised learning method, but it is also possible to generate a determination engine by an unsupervised learning method.

FIG. 4 is a block diagram illustrating a schematic configuration of a determiner generation system 40 for generating a learned model of the determination engine 14a. As illustrated in FIG. 4, the determiner generation system 40 includes an attribute pattern input unit 41, an attribute list generation unit 42, an attribute image generation unit 43, a learning data generation unit 44, a learning data storage unit 45, and a neural network 46. Incidentally, the determiner generation system 40 can be configured with one or multiple computers. In other words, all of the blocks shown in FIG. 4 may be implemented by one computer, or the blocks shown in FIG. 4 may be dispersedly arranged in multiple computers connected via a network.

The attribute pattern input unit 41 receives input of attribute patterns corresponding to predetermined engineer categories. An attribute pattern is data that represent, regarding each one of various types of engineers, which attribute among multiple kinds of attributes (skills) has correspondence to the skill or qualification that the engineer should have (or desirably has). The attribute pattern may be in an arbitrary format.

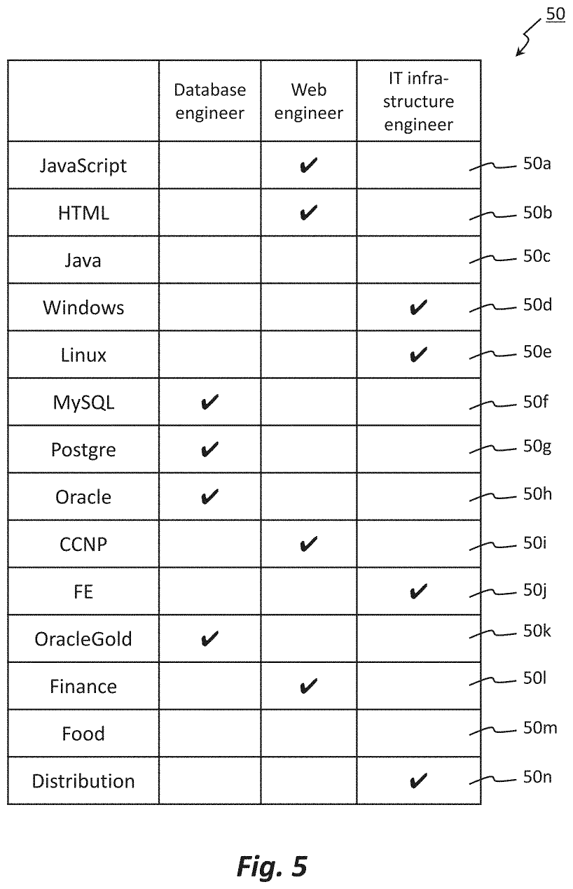

The attribute list generation unit 42 generates, regarding each engineer category, an attribute list in which checkboxes of attributes falling in the engineer category are checked, based on an attribute pattern that the attribute pattern input unit 41 has received. FIG. 5 is a schematic diagram illustrating an exemplary attribute list generated by the attribute list generation unit 42. Incidentally, the example illustrated in FIG. 5 is, for convenience of explanation, a classification table that shows respective attribute patterns of engineers of three types of categories, i.e., the database engineer, the web engineer, and the IT infrastructure engineer, one engineer in each category. However, the number of engineer categories is arbitrary, and attribute patterns of multiple engineers may be used for each engineer category.

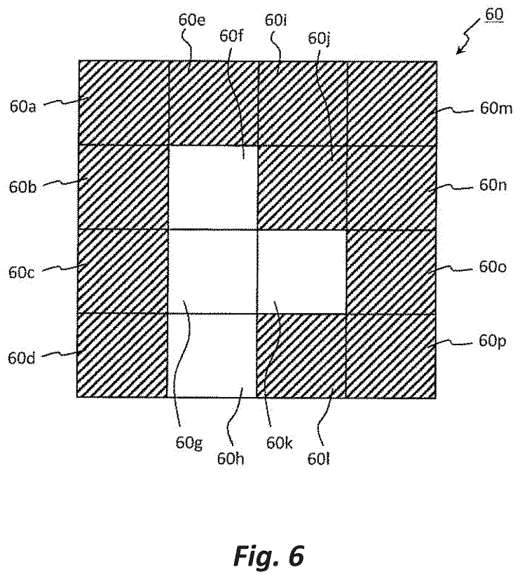

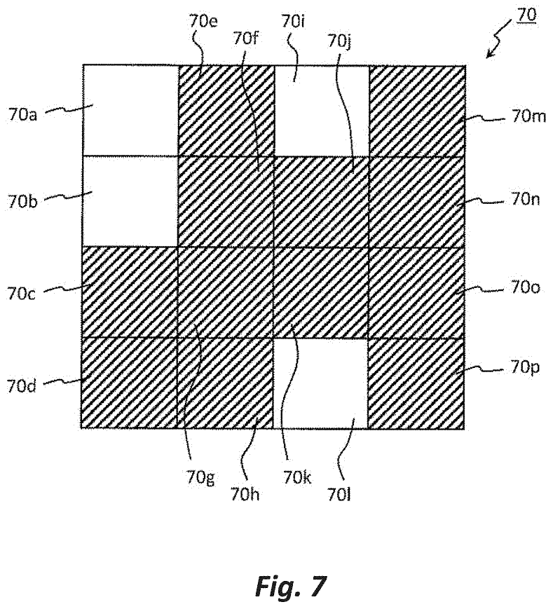

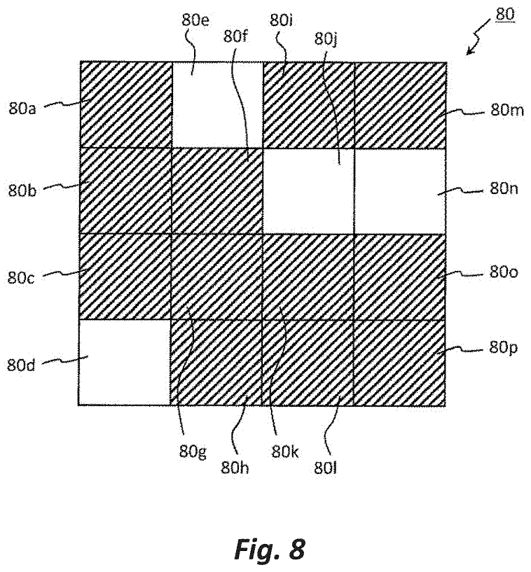

The attribute image generation unit 43, as is the case with the attribute image generation unit 13, converts the attribute list generated by the attribute list generation unit 42 into an attribute image having an n-row× n-column matrix of squares (n is an integer of 2 or more). The attribute list shown in FIG. 5 is here converted by the attribute image generation unit 43 into respective attribute images as shown in FIGS. 6 to 8 of the engineer categories. FIG. 6 shows an attribute image 60 obtained by converting the attribute list of the database engineer shown in FIG. 5. FIG. 7 shows an attribute image 70 obtained by converting the attribute list of the web engineer shown in FIG. 5. FIG. 8 shows an attribute image 80 obtained by converting the attribute list of the IT infrastructure engineer shown in FIG. 5.

Each of the attribute images 60 to 80, as is the case with the attribute image 30, has a 4-row×4-column matrix of squares. In the attribute image 60, the squares 60a to 60n correspond to the attribute checkboxes 50a to 50n of the attribute list 50. Regarding the database engineer, the squares 60f, 60g, 60h, and 60k corresponding to the attribute checkboxes 50f, 50g, 50h, and 50k, which are checked in the attribute list 50, are colored in white, and the squares 60a to 60e, 60i, 60j, and 60l to 60n corresponding to the attribute checkboxes 50a to 50e, 50i, 50j, 501 to 50n, which are not checked, are colored in black. The squares 60o and 60p, which correspond to no attribute checkbox, are also colored in black. Incidentally, in FIG. 6 as well, the squares to be colored in black are indicated by hatching, for convenience sake.

In the attribute image 70, the squares 70a to 70n correspond to the attribute checkboxes 50a to 50n of the attribute list 50. Regarding the web engineer, the squares 70a, 70b, 70i, and 701 corresponding to the attribute checkboxes 50a, 50b, 50i, and 50l, which are checked in the attribute list 50, are colored in white, and the squares 70c to 70h, 70j to 70k, and 70m to 70n corresponding to the attribute checkboxes 50c to 50h, 50j to 50k, and 50m to 50n, which are not checked, are colored in black. The squares 70o and 70p, which correspond to no attribute checkbox, are also colored in black. Incidentally, in FIG. 7 as well, the squares to be colored in black are indicated by hatching, for convenience sake.

In the attribute image 80, the squares 80a to 80n correspond to the attribute checkboxes 50a to 50n of the attribute list 50. Regarding the IT infrastructure engineer, the squares 80d, 80e, 80j, and 80n corresponding to the attribute checkboxes 50d, 50e, 50j, and 50n, which are checked in the attribute list 50, are colored in white, and the squares 80a to 80c, 80f to 80i, and 80k to 80m corresponding to the attribute checkboxes 50a to 50c, 50f to 50i, and 50k to 50m, which are not checked, are colored in black. The squares 80o and 80p, which correspond to no attribute checkbox, are also colored in black. Incidentally, in FIG. 8 as well, the squares to be colored in black are indicated by hatching, for convenience sake.

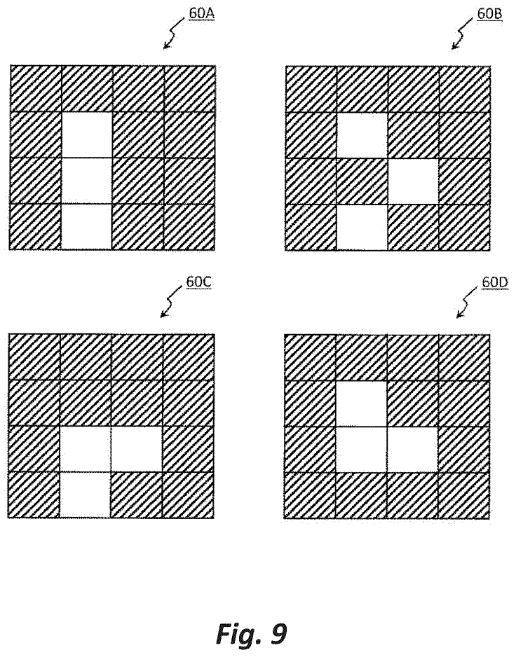

When the attribute images 60 to 80 are generated by the attribute image generation unit 43 in this way, the learning data generation unit 44 generates learning data sets to be learned by the neural network on the basis of these attribution images 60 to 80. The learning data sets are generated by reducing white squares by only one or more in number in each of the attribute images 60 to 80. For example, by reducing the white squares in the attribute image 60 shown in FIG. 6 by one in number, four types of learning data sets 60A to 60D shown in FIG. 9 are generated.

In this way, the learning data generation unit 44 generates multiple learning data sets by reducing the white squares of each of the attribute images 60 to 80 by only one or more in number, adds a label indicating the engineer category to each of the generated learning data sets, and stores the same in the learning data storage unit 45. In other words, to the learning data set generated from the attribute image 60, a label indicating that it is a learning data set of the “database engineer” is added. To the learning data set generated from the attribute image 70, a label indicating that it is a learning data set of the “web engineer” is added. To the learning data set generated from the attribute image 80, a label indicating that it is a learning data set of the “IT infrastructure engineer” is added.

In this way, after multiple learning data sets are generated, the neural network 46 is caused to learn the learning data sets, whereby the learned model 14a is obtained. This learned model 14a is used as a determination engine in the determination unit 14 shown in FIG. 1.

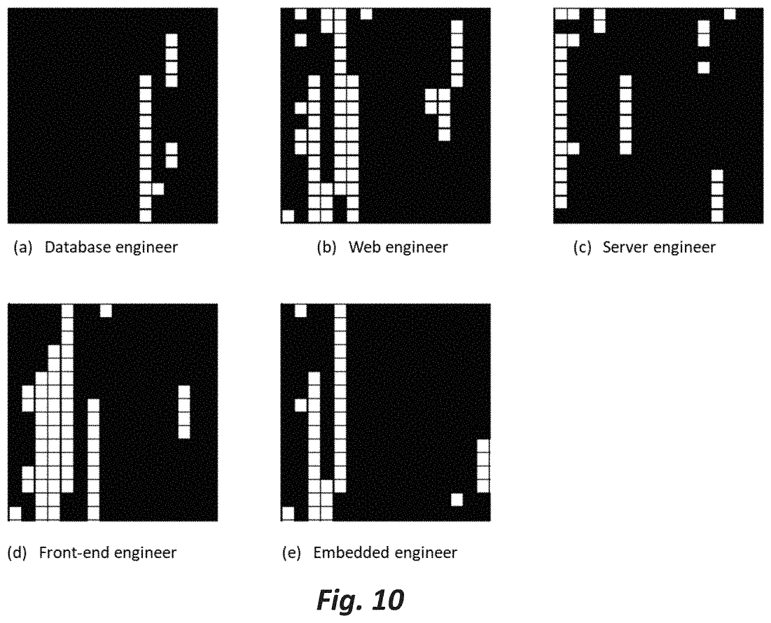

The following description explains exemplary classification of engineers using the learned model generated as described above, while referring to FIGS. 10 to 14.

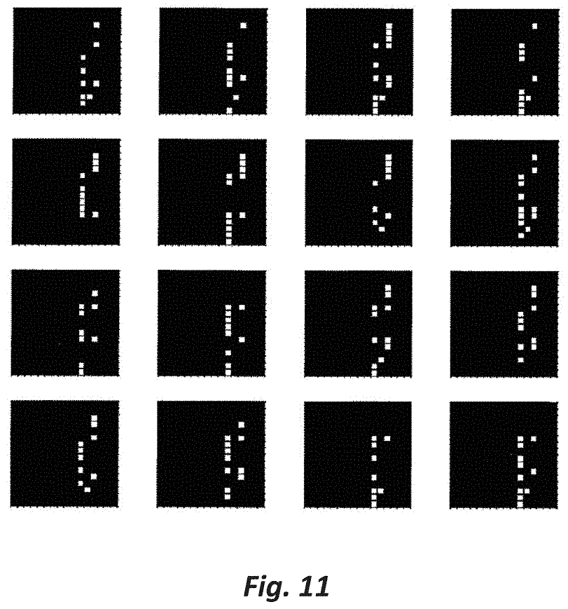

FIG. 10 shows attribute images of engineers of five types (a database engineer, a web engineer, a server engineer, a front-end engineer, and an embedded engineer). In the example shown in FIG. 10, each attribute image has a 16-row×16-column matrix of squares. In other words, in this example, the attribute image is generated using a check list (attribute list) having up to 256 items. From each of these attribute images, 150 learning data sets are generated by reducing the white squares by only one or more in number. FIG. 11 shows some of the 150 learning data sets generated from the attribute image of the database engineer shown in (a) of FIG. 10.

In this way, by causing the neural network 46 to learn 150 learning data sets generated from each of the attribute images of the five types of engineers, i.e., 750 learning data sets in total, the learned model 14a is generated.

The determination performance with use of the learned model 14a was evaluated, by using the information processing device 10 (see FIG. 1) in which the learned model 14a was installed, and classifying an engineer having two types of skills as a database engineer and a front-end engineer, as a person to be classified.

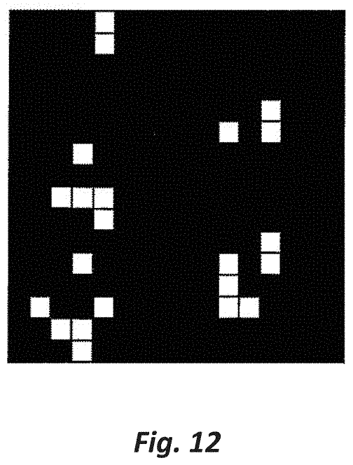

Here, an attribute image of the engineer (person to be classified), which was input for verification, is as shown in FIG. 12. Incidentally, as shown in (a) and (d) of FIG. 10, the distribution of the attributes of the database engineer and the distribution of the attributes of the front-end engineer are relatively independent from each other. In other words, as is clear from (a) of FIG. 10, in the case of the database engineer, white areas are distributed in the right half of the attribute image; in the case of the front-end engineer, as shown in (d) of FIG. 10, white areas are distributed in the left half of the attribute image. In the case of a person to be classified shown in FIG. 12, which was used for verification, the attribute image had both of the attribute distribution in the case of the database engineer (white areas distributed in the left half) and the attribute distribution in the case of the front-end engineer (white areas distributed in the right half).

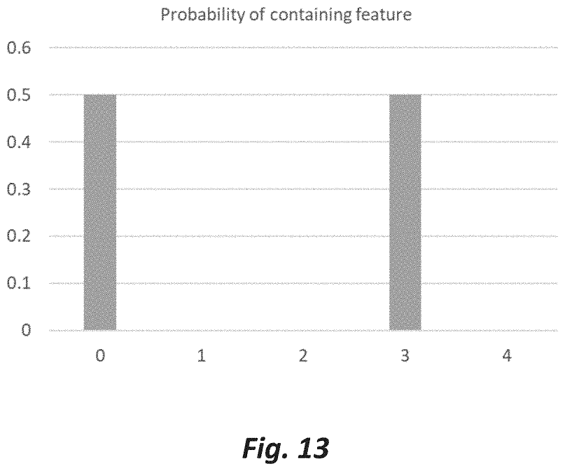

FIG. 13 shows results of determination by the learned model 14a. Incidentally, in FIG. 13, the classification category “0” corresponds to the database engineer, the classification category “1” to the web engineer, the classification category “2” to the server engineer, the classification category “3” to the front-end engineer, and the classification category “4” to the embedded engineer). As is clear from FIG. 13, regarding the attribute image of the persons to be classified for verification shown in FIG. 12, it was determined by the learned model 14a that the probability of having a feature amount corresponding to the database engineer (classification category 0) was about 0.5, and the probability of having a feature amount corresponding to the front-end engineer (classification category 3) was about 0.5. In other words, the person to be classified, used for verification here, was correctly determined to be classified as both of the database engineer and the front-end engineer.

In this way, in Embodiment 1, regarding each of multiple kinds of attributes input, an attribute value that can be converted to a binary value is input, and an area in an attribute image corresponding to each attribute is colored in a color (white or black) corresponding to the attribute value by the attribute image generation unit 13. In addition, when the learned model 14 is generated, such attribute images are used as learning data sets. Thereby, a learned model having a high determination accuracy can be generated. Besides, by using this learned model as the determination engine, persons to be classified having a variety of attributes can be classified with a high accuracy.

The information processing device disclosed herein, therefore, is used with respect to, for example, ICT engineers as persons to be classified, and receives input about whether the respective persons have each of various attributes relating to skills, experiences, qualifications, etc. Thereby, the information processing device can determine which type of engineer each person is classified as. It should be noted that the person to be classified is not limited to an ICT engineer, and the present invention can be applied to classification processing in various fields.

Embodiment 1 is described as above, but this description describes merely an example and does not limit the present invention. For example, the number of items in the check list, and the number of learning data sets generated from the attribute image are not limited to those of the above-described specific example. They may be set to arbitrary numbers.

### Embodiment 2

The following description describes an information processing device 90 according to Embodiment 2. The constituent elements having the same functions as those described in conjunction with Embodiment 1 are denoted by the same reference symbols, and detailed descriptions of the same are omitted.

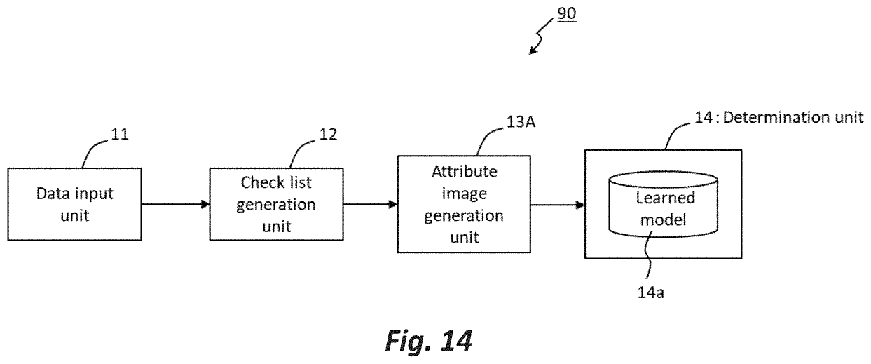

An information processing device 90, as shown in FIG. 14, is different from the information processing device 10 in Embodiment 1 in that the information processing device 90 includes an attribute image generation unit 13A in the place of the attribute image generation unit 13 shown in FIG. 1. The attribute image generation unit 13A generates an attribute image that indicates an achievement degree of each skill with any of three colors of red, green, and blue (RGB).

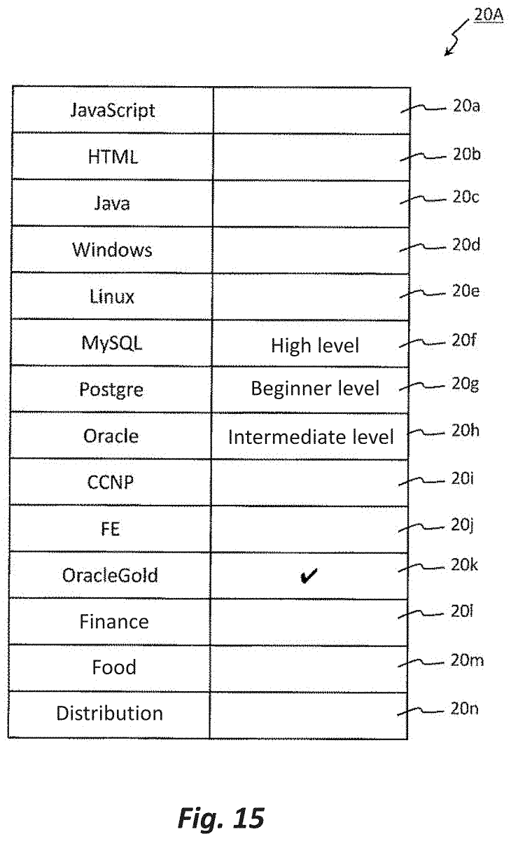

For example, a check list 20A shown in FIG. 15 is generated on the basis of attribute information of a person to be classified. This check list 20A is different from the check list 20 shown in FIG. 2 in conjunction with Embodiment 1 in that the achievement degrees of skills can be input at three-grade levels of “high level”, “intermediate level”, and “beginner level”. More specifically, in the check list 20A shown in FIG. 15, the checkboxes 20f, 20g, 20h, and 20k indicate that the person to be classified has a high-level skill in MySQL (registered trademark), a beginner-level skill in Postgre (registered trademark), an intermediate-level skill in Oracle (registered trademark), and a qualification in OracleGold (registered trademark).

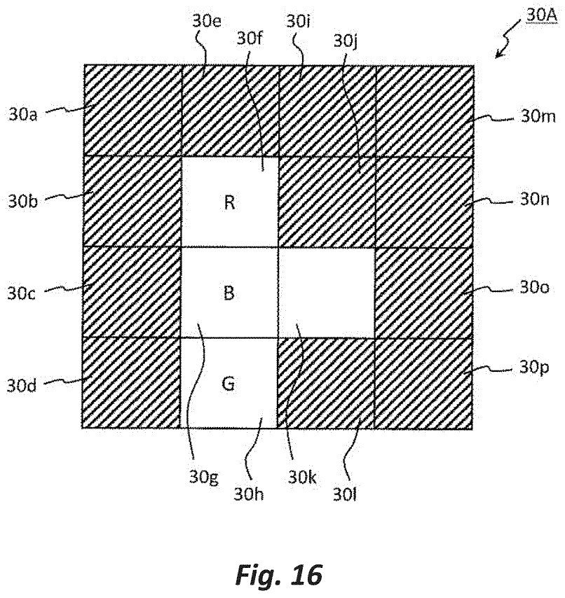

The attribute image generation unit 13A converts the check list 20A into an attribute image 30A shown in FIG. 16. The attribute image 30A is an image having a 4-row×4-column matrix of squares, in which the squares 30a to 30n correspond to the checkboxes 20a to 20n of the check list 20A. The square 30f corresponding to the checkbox 20f in the check list 20A containing “high level” is colored in red, the square 30g corresponding to the checkbox 20g containing “beginner level” is colored in blue, the square 30h corresponding to the checkbox 20h containing “intermediate level” is colored in green, and the square 30k corresponding to the checkbox 20k, which is checked, is colored in white. The squares corresponding to the checkboxes 30a to 30e, 30i, 30j, and 30l to 30n, which are not checked, are colored in black. The squares 30o and 30p, which correspond to no checkbox, are also colored in black. Incidentally, in FIG. 16, for convenience sake, the squares to be colored in black are indicated by hatching. The square in red (30f) is denoted by “R”. The square in blue (30g) is denoted by “B”. The square in green (30h) is denoted by G.

The attribute image generated in this way is input to the determination unit 14, and which one of predetermined engineer categories the person to be classified belongs to is determined by the determination engine 14a.

Incidentally, in Embodiment 2, learning data indicating achievement degrees (“high level”, “intermediate level”, and “beginner level”) of respective skills by three colors of RGB are used as a learning data set used when the determination engine 14a is generated.

In this way, in Embodiment 2, regarding each of multiple kinds of attributes input, an attribute value of ternary or more notation is input, and an area in an attribute image corresponding to each attribute is colored in a color corresponding to the attribute value by the attribute image generation unit 13A. This makes it possible to process a larger amount of information regarding attributes of a person to be classified, as compared with Embodiment 1 in which the attribute value of each attribute is represented by white or black. This therefore allows for more detailed classification.

Embodiment 2 described above is merely an example, and can be varied in many ways. For example, in the above-described example, regarding some of multiple kinds of attributes, each attribute can be represented by a ternary value of the achievement degree (“high level”, “intermediate level”, and “beginner level”). The value representing the achievement degree, however, may be binary. In this case, any two colors among RGB are enough as colors for representing the achievement degree. In contrast, for example, regarding at least some of multiple kinds of attributes, each attribute may be represented by an attribute value of quaternary or more notation. In this case, areas in an attribute image corresponding to these attributes may be represented by arbitrary four or more colors.

As described above, two embodiments of the present invention are described, but each of these embodiments described above is merely an example and does not limit the present invention. For example, in Embodiments 1 and 2, the generation of a learned model by a supervised learning method is described as an example, but a learned model may be generated by an unsupervised learning method utilizing deep learning or the like.

Each block in the embodiments described above (including modification examples) may be formed with a hardware circuit. Each block may be individually formed in one chip, or a part or an entirety of the blocks may be formed in one chip, with use of a semiconductor device such as a large scale integrated circuit (LSI).

It should be noted that LSI is mentioned here, but it is referred to as IC, system LSI, super LSI, or ultra LSI, depending on the degree of integration.

Further, the circuit integration is achieved not exclusively with LSI, but it may be achieved with a dedicated circuit or a general-purpose processor. It is also possible to utilize a field programmable gate array (FPGA) that is programmable after the manufacture of LSI, or to utilize a reconfigurable processor in which the connection or setting of the circuit cells inside LSI can be reconfigured after the manufacture of LSI.

Still further, when a technique of circuit integration that can replace LSI is brought about by the developments in semiconductor technologies or another technology derived therefrom, the functional block integration may be achieved by using such a technique. One possibility is to apply biotechnology or the like.

Still further, a part or an entirety of the functional blocks of each embodiment described above may be implemented by a program. Then, a part or an entirety of processing operations of each functional block of each embodiment described above is performed by a central processing unit (CPU), a microprocessor, a processor, or the like in a computer. The programs for performing respective processing operations are stored in a storage device such as a hard disk or a read-only memory (ROM), and is read out by a ROM or a random-access memory (RAM) so as to be executed. The storage device (storage medium) is a non-transitory tangible storage, and a tape, a disk, a card, a semiconductor memory, a programmable logic circuit, or the like can be used as the storage device, for example.

Still further, each processing operation in the embodiments described above may be implemented by hardware, or alternatively, may be implemented by software (which encompasses the implementation with an operating system (OS), middleware, or a predetermined library). Alternatively, it may be implemented by mixture of processing operations of software and hardware. Incidentally, needless to say, in a case where a digital content providing system according to any of the above-described embodiments is implemented by hardware, it is necessary to adjust timings for performing processing operations. In the foregoing descriptions of the embodiments, for convenience of description, description of details is omitted regarding the timing adjustment of various types of signals required in actual hardware design.

The present invention can also be described as follows.

An information processing device according to a first configuration of the present invention includes:
an input unit for causing attribute values that can be converted to at least binary values to be inputted for each of multiple kinds of attributes pertaining to a person to be classified;
an attribute image generation unit for generating an attribute image having multiple areas corresponding to the multiple kinds of attributes, each of the multiple areas exhibiting a color that corresponds to the attribute value inputted for the attribute corresponding thereto; and
a determination engine having a learned model that has learned a correlation between a pattern of the attribute values and a result of classification on the basis of a learning data set in which the pattern of the attribute values with respect to the multiple kinds of attributes is represented in the same format as that for the attribute image,
wherein the determination engine outputs the result of classification of the persons to be classified, on the basis of the attribute image generated by the attribute image generation unit.

According to this first configuration, the determination engine includes a learned model. This leaned model is a learned model obtained through the following process: a pattern of attribute values with respect to multiple kinds of attributes is represented as an attribute image having multiple areas corresponding to these multiple kinds of attributes, each of the multiple areas exhibiting a color that corresponds to the attribute value for the attribute corresponding thereto; learning is carried out by using this attribute image as a learning data set; and a correlation between the pattern of the attribute values and the result of classification is learned. Then, attribute values that can be converted to at least binary values are caused to be inputted for each of multiple kinds of attributes pertaining to a person to be classified. An attribute image is generated that has multiple areas corresponding to the multiple kinds of attributes, each of the multiple areas exhibiting a color that corresponds to the attribute value inputted by the input unit for the attribute corresponding thereto. The determination engine having the learned model is caused to determine the classification result of the person to be classified, on the basis of the generated attribute image. In this way, by using an attribute image that has multiple areas corresponding to multiple kinds of attributes, each of the multiple areas exhibiting a color that corresponds to the attribute value for the attribute corresponding thereto, persons to be classified who have a wide variety of attributes can be classified easily and accurately.

An information processing device according to a second configuration of the present invention is the information processing device of the first configuration further characterized in that
the multiple kinds of attributes include attributes relating to a skill, an experience, or a qualification, and an attribute value with respect to the attribute represents whether or not the person to be classified has the skill, the experience, or the qualification, and an area corresponding to the attribute in the attribute image exhibits either one of two colors according to whether or not the person to be classified has the skill, the experience, or the qualification.

With this second configuration, in a case where engineers are to be classified according to their skills or qualifications, for example, in a field with a wide variety of skills or qualifications such as ICT engineering, the skills and the qualifications that each engineer holds are represented by an attribute image, which makes it possible to classify engineers having a wide variety of attributes easily and accurately.

An information processing device according to a third configuration of the present invention is the information processing device of the second configuration further characterized in that
an attribute value with respect to at least one attribute regarding the skill, the experience, or the qualification represents one of two or more-grade levels regarding the skill, the experience, or the qualification that the person to be classified holds; and an area in the attribute image corresponding to the attribute exhibits one of two or more colors according to the level of the skill, the experience, or the qualification.

With this third configuration, for example, when at least one of a skill, an experience, or a qualification included in attributes is considered, one of two or more-grade levels regarding the skill, the experience, or the qualification can be entered. For example, one of two or more-grade levels can be entered regarding the achievement degree of a certain skill. For example, regarding an experience of development using a specific programming language, a length of the experience such as “less than three years”, “three years or longer and less than five years”, “five years or longer”, can be entered. Regarding a certain qualification, a level such as “beginner level”, “intermediate level”, “high level”, or “first grade”, “second grade”, etc., can be entered. Thus, the third configuration allows more detailed information to be entered regarding attributes of a person to be classified. Besides, areas in an attribute image corresponding to the attributes can be represented by two or more colors according to the levels of the attributes, whereby the amount of information that the attribute image can hold can be increased. This enables more detailed classification on the basis of more information.

An information processing method according to the present invention is an information processing method executed by a computer, the method including:
inputting, in the computer, respective attribute values that can be converted to at least binary values, with respect to multiple kinds of attributes pertaining to a person to be classified;
generating, with the computer, an attribute image that has multiple areas corresponding to the multiple kinds of attributes, each of the multiple areas exhibiting a color that corresponds to the attribute value inputted for the attribute corresponding thereto; and
outputting a classification result of the person to be classified, on the basis of the attribute image generated by the computer, from a determination engine having a learned model that has learned a correlation between the pattern of the attribute values and the result of classification on the basis of a learning data set in which the pattern of the attribute values for the multiple kinds of attributes is represented in the same format as that for the attribute image.

This information processing method, as is the case with the information processing device according to the first configuration, makes it possible to easily and accurately classify persons to be classified who have a wide variety of attributes, by using an attribute image that has multiple areas corresponding to multiple kinds of attributes, each of the multiple areas exhibiting a color that corresponds to the attribute value for the attribute corresponding thereto.

A program according to the present invention is a program to be read and executed by a computer, the program causing the computer to execute the steps of:
inputting respective attribute values that can be converted to at least binary values, with respect to multiple kinds of attributes pertaining to a person to be classified;
generating an attribute image that has multiple areas corresponding to the multiple kinds of attributes, each of the multiple areas exhibiting a color that corresponds to the attribute value inputted by the input unit for the attribute corresponding thereto; and
outputting a classification result of the person to be classified, on the basis of the attribute image generated by the computer, from a determination engine having a learned model that has learned a correlation between the pattern of the attribute values and the result of classification on the basis of a learning data set in which the pattern of the attribute values with respect to the multiple kinds of attributes is represented in the same format as that for the attribute image.

This program enables to easily and accurately cause the computer to execute a processing operation for classifying persons having a wide variety of attributes, by using an attribute image that has multiple areas corresponding to multiple kinds of attributes, each of the multiple areas exhibiting a color that corresponds to the attribute value for the attribute corresponding thereto.

In addition, a recording medium that stores the above-described program is also one aspect of the present invention.

A leaning model generation device according to the present invention includes:
an attribute pattern input unit that inputs a pattern of attribute values with respect to multiple kinds of attributes;
an attribute image generation unit for generating, from the pattern of attribute values, an attribute image having multiple areas corresponding to the multiple kinds of attributes, each of the multiple areas exhibiting a color that corresponds to the attribute value inputted for the attribute corresponding thereto;
a learning data generation unit for generating a plurality of learning data sets from each of these attribute images; and
a leaning unit for generating a learned model that has learned a correlation between the pattern of the attribute values and a result of classification on the basis of the learning data sets.

This learning model generation device uses, as learning data, an attribute image that has multiple areas corresponding to the multiple kinds of attributes of a person to be classified, each of the multiple areas exhibiting a color that corresponds to the attribute value inputted by the input unit for the attribute corresponding thereto. This enables efficient learning of a lot of learning data having a wide variety of attributes, as compared with a case where text data and the like are used as learning data. As a result, it is possible to generate a learned model that can output highly reliable determination result regarding a correlation between a pattern of attribute values with respect to multiple kinds of attributes and a result of classification.

A leaning model generation method according to the present invention includes:
inputting a pattern of attribute values with respect to multiple kinds of attributes;
generating, from the pattern of attribute values, an attribute image having multiple areas corresponding to the multiple kinds of attributes, each of the multiple areas exhibiting a color that corresponds to the attribute value inputted for the attribute corresponding thereto;
generating a plurality of learning data sets from each of these attribute images; and
generating a learned model that has learned a correlation between the pattern of the attribute values and a result of classification on the basis of the learning data sets.

This learning model generation method uses, as learning data, an attribute image that has multiple areas corresponding to the multiple kinds of attributes of a person to be classified, each of the multiple areas exhibiting a color that corresponds to the attribute value inputted by the input unit for the attribute corresponding thereto. This enables efficient learning of a lot of learning data having a wide variety of attributes, as compared with a case where text data and the like are used as learning data. As a result, it is possible to generate a learned model that can output highly reliable determination result regarding a correlation between a pattern of attribute values with respect to multiple kinds of attributes and a result of classification.

### DESCRIPTION OF REFERENCE SIGNS

10: information processing device
11: data input unit
12: check list generation unit
13-13A: attribute image generation unit
14: determination unit (determination engine)
14a: learned model
40: determiner generation system
41: attribute pattern input unit
42: attribute list generation unit
43: attribute image generation unit
44: learning data generation unit
45: learning data storage unit
46: neural network

1. An information processing device comprising:
an input unit configured to cause attribute values that can be converted to at least binary values to be inputted for each of multiple kinds of attributes pertaining to a person to be classified;
an attribute image generation unit configured to generate an attribute image having multiple areas corresponding to the multiple kinds of attributes, each of the multiple areas exhibiting a color that corresponds to the attribute value inputted for the attribute corresponding thereto; and
a determination engine having a learned model that has learned a correlation between a pattern of the attribute values and a result of classification on the basis of a learning data set in which the pattern of the attribute values with respect to the multiple kinds of attributes is represented in the same format as that for the attribute image,
wherein the determination engine outputs the result of classification of the persons to be classified, on the basis of the attribute image generated by the attribute image generation unit.

2. The information processing device according to claim 1,
wherein the multiple kinds of attributes include attributes relating to a skill, an experience, or a qualification, and an attribute value with respect to the attribute represents whether or not the person to be classified has the skill, the experience, or the qualification, and an area corresponding to the attribute in the attribute image exhibits either one of two colors according to whether or not the person to be classified has the skill, the experience, or the qualification.

3. The information processing device according to claim 2,
wherein an attribute value with respect to at least one attribute regarding the skill, the experience, or the qualification represents one of two or more-grade levels regarding the skill, the experience, or the qualification that the person to be classified holds, and an area in the attribute image corresponding to the attribute exhibits one of two or more colors according to the level of the skill, the experience, or the qualification.

4. An information processing method executed by a computer, the method comprising:
inputting, in the computer, respective attribute values that can be converted to at least binary values, with respect to multiple kinds of attributes pertaining to a person to be classified;
generating, with the computer, an attribute image that has multiple areas corresponding to the multiple kinds of attributes, each of the multiple areas exhibiting a color that corresponds to the attribute value inputted for the attribute corresponding thereto; and
outputting a classification result of the person to be classified, on the basis of the attribute image generated by the computer, from a determination engine having a learned model that has learned a correlation between the pattern of the attribute values and the result of classification on the basis of a learning data set in which the pattern of the attribute values with respect to the multiple kinds of attributes is represented in the same format as that for the attribute image.

5. (canceled)

6. A non-transitory computer readable recording medium that stores a program causing a computer to execute processing comprising:
inputting respective attribute values that can be converted to at least binary values, with respect to multiple kinds of attributes pertaining to a person to be classified;
generating an attribute image that has multiple areas corresponding to the multiple kinds of attributes, each of the multiple areas exhibiting a color that corresponds to the attribute value inputted by the input unit for the attribute corresponding thereto; and
outputting a classification result of the person to be classified, on the basis of the attribute image generated by the computer, from a determination engine having a learned model that has learned a correlation between the pattern of the attribute values and the result of classification on the basis of a learning data set in which the pattern of the attribute values with respect to the multiple kinds of attributes is represented in the same format as that for the attribute image.

7. A leaning model generation device comprising:
an attribute pattern input unit that inputs a pattern of attribute values with respect to multiple kinds of attributes;
an attribute image generation unit configured to generate, from the pattern of attribute values, an attribute image having multiple areas corresponding to the multiple kinds of attributes, each of the multiple areas exhibiting a color that corresponds to the attribute value inputted for the attribute corresponding thereto;
a learning data generation unit configured to generate a plurality of learning data sets from each of these attribute images; and
a leaning unit configured to generate a learned model that has learned a correlation between the pattern of the attribute values and a result of classification on the basis of the learning data sets.

8. A leaning model generation method comprising:
inputting a pattern of attribute values with respect to multiple kinds of attributes;
generating, from the pattern of attribute values, an attribute image having multiple areas corresponding to the multiple kinds of attributes, each of the multiple areas exhibiting a color that corresponds to the attribute value inputted for the attribute corresponding thereto;
generating a plurality of learning data sets from each of these attribute images; and
generating a learned model that has learned a correlation between the pattern of the attribute values and a result of classification on the basis of the learning data sets.
